(19) United States
(12) Patent Application Publication
(10) Pub. No.: US 2024/0193511 A1
(43) Pub. Date: Jun. 13, 2024

(54) AUGMENTED REALITY SYSTEM WITH ITEM TRACKING FOR EVENT PREPARATION

(71) Applicant: INTERNATIONAL BUSINESS MACHINES CORPORATION, ARMONK, NY (US)

(72) Inventors: Al Chakra, Apex, NC (US); Alejandro Aguilar Esteban, Watertown, MA (US); Alexander David Burke, Littleton, MA (US); Mingqing(Mindy) Li, San Jose, CA (US)

(21) Appl. No.: 18/063,038

(22) Filed: Dec. 7, 2022

(51) Int. Cl. G06Q 10/0631

(52) U.S. Cl. CPC G06Q 10/06313

(57) ABSTRACT

A method, computer system, and a computer program product for event-related item tracking are provided. A first computer receives from an event database associated with personal information management software a reminder of an upcoming event for a first user. The first computer retrieves an electronic list of items needed by the first user for the upcoming event. The first computer retrieves, from a location database, location information of a first item from the electronic list of items. The location database was generated using image information of the first item. The first computer transmits the electronic list of items and the location information of the first item for presentation to the first user.

### BACKGROUND

The present invention relates generally to technologies such as computers, cameras, augmented reality, and artificial intelligence and harnessing these technologies to provide an improved reminder system.

### SUMMARY

A method, computer system, and a computer program product for event-related item tracking are provided. A first computer receives from an event database a reminder of an upcoming event for a first user. The first computer retrieves an electronic list of items needed by the first user for the upcoming event. The first computer retrieves, from a location database, location information of a first item from the electronic list of items. The location database was generated using image information of the first item. The first computer transmits the electronic list of items and the location information of the first item for presentation to the first user.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment for item-related event tracking according to at least one embodiment;

FIG. 2 illustrates an augmented reality view with a location reminder according to at least one embodiment;

FIG. 3A is an operational flowchart illustrating an event-related item tracking process according to at least one embodiment;

FIG. 3B is an operational flowchart illustrating a user side of the event-related item tracking process according to at least one embodiment;

FIG. 4 is a graph of vector features of event descriptions according to at least one embodiment; and

FIG. 5 is a block diagram illustrating a computer environment with multiple computer systems in which the item-related event tracking process described for FIGS. 3A and 3B may be implemented and which provides examples of details about certain computers and connections of the networked computer environment shown in FIG. 1.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a method, computer system, and computer program product for reminding a person of an upcoming event, reminding the person of various items that the person will need for the upcoming event, tracking the locations of those items needed for the event, and guiding the person to and/or near the location of those items to help with preparation, e.g. for departure to the event. The present embodiments harness a variety of technologies such as computers, cameras, calendar databases, artificial intelligence, augmented reality, and/or natural language processing with semantic similarity clustering to help achieve these objectives. The present embodiments provide an improvement in the artificial intelligence field of computer assistance help to prepare for upcoming tasks and events and in an automated manner to identify and prioritize needed items. In addition, the present embodiments implement object location tracking based on image capture and without needing wireless signal emission structure such as an RFID chip or similar technology. This ability to avoid needing RFID chips may help to allow location tracking using a reduced carbon footprint of these physical devices which is advantageous for green technology and fighting climate change. The present embodiments may also be paired with virtual/smart assistants for enhanced communication and enhanced communication convenience of the user.

When traveling, preparing for an event, or doing a specific task, people tend to forget items that they will need. Many tasks require a person to remember to bring something such as a pen, a car key, a wallet, a mask, or a passport and/or additionally for engaging in the activity once the person arrives at the destination. For a variety of reasons, however, sometimes a person forgets to bring one or more of such important items. Sometimes when a person remembers an item, the person struggles to timely find the item. Such a struggle can delay and interfere with a successful departure and completion of the event. The present embodiments help automatically generate an electronic list of items to bring for an event. The list is generated based on the particular task that is to be performed. The present embodiments also may perform continued tracking of the locations of the items on the list and also may guide the user to the locations at the time of preparation and item gathering in advance of departure for the event. The present embodiments provide reminder information and item tracking in a continuous and dynamic manner. The present embodiments help users make best use of activity preparation time and to prioritize items that are needed to complete a task. The references to “list” throughout this disclosure may refer to a respective electronic list.

Many phones, tablets, smart glasses, smart windshields, heads-up displays, and other electronic devices have augmented reality features. Augmented reality is an enhanced version of the real physical world that is achieved through the use of digital visual elements, sound, and/or other sensory stimuli and delivered via technology. For visual-based augmented reality, computer-generated fictional content may be presented over a view that a user has of the real word. The fictional content refers to the concept that the superimposed content is being present in the real world area that is being viewed, is added to the view of the real world area using the augmented reality technology, and the view is altered so that the user is able to see both real world images and the superimposed fictional aspects together in the same view.

The present embodiments incorporate augmented reality in order to help guide a user to find the items needed to be ready for an event. For example, at least some of the present embodiments include a wearable eye system such as smart glasses and/or an audible system (or as otherwise discussed herein) that identifies task-based critical items and, via augmented reality presented on the system, e.g. displayed on the wearable eye system and/or played on the audible system for those with impaired vision, guides the wearer to the locations of these items. The present embodiments automatically trigger an augmented reality notification of the location of an object when the user needs the object in preparation for a task. The present embodiments may generate the needed list of items by pulling items from other databases about needed items. Locations of items may be stored in some databases and then retrieved for guiding the user to the location. The present embodiments may use statistics, artificial intelligence such as natural language processing, and semantic similarity clustering to perform the pulling and list generating. In some embodiments, users may manually feed information to the reminder system in order to personalize the list of what the user would like to bring for the event. The system may track the location of items. Then, at the time of preparation for event departure the present embodiments may help remind the user what was placed on the list and may help guide the user to find the desired items. The system captures information continuously and takes note of the needed items. When the time comes to retrieve the required object, the present embodiments include pulling information to display to the user and guide the user to the object.

In one exemplary embodiment, a person wears a set of smart glasses enabled with the features of the present embodiment as the user prepares for a trip for the holidays. The system detects the user has placed the user's passport on the bed while the user is packing clothes for the trip. If the user forgets to bring the passport or forgets to mark the passport as ready, the system alerts the user when it is time to leave. The system is able to pull information of the last location of the passport, recognize that the passport is not currently within the possession, travel clothing, and/or travel bags that the user is ready to take, and remind the user to retrieve the passport by displaying augmented reality instructions and/or directions to the bed on which the passport is laying. The present embodiments may trigger notification when the required item from the list is not within the reach of the user.

In another exemplary embodiment, the user works on a project and the reminder system shows tools that would help complete the project and helps guide the user to the location(s) of the tools. Other embodiments are also specifically contemplated as within the scope of the invention.

The present embodiments help provide a user with a prioritized list of what is needed and/or is important for an event and helps track locations of items from the list. The present embodiments may gather data from a device of the user (or software associated with a device of the user) to determine upcoming events and to generate user-specific to-bring lists for upcoming events. Embodiments of the invention may connect to personal information management software that contains the user's calendar for further automation. The present embodiments may implement augmented reality to not only display a reminder but also to guide the user to the last-known location of the object. The augmented reality may include an indicator (such as an arrow) superimposed over a field of image view. The indicator may guide the user to the last-seen location of the object. The present embodiments harness the use of image data, e.g. images captured by one or more cameras, to track the locations of objects that are needed for to-bring lists. The present embodiments may perform continuous tracking and/or monitoring of item location, for example, by capturing multiple images of the surroundings of the user and comparing newly captured images with previously captured images in order to identify item locations and location changes. The present embodiments may perform one or more of machine learning, object recognition, pattern recognition, etc. in order to determine and track item locations. Images may be captured to track locations of objects including their proximity to other objects, even if the objects and/or other objects in the surrounding environment are not emitting wireless communication signals. This continuous tracking and/or monitoring may include the use of computer vision, e.g. camera vision, and object detection. Thus, the present embodiments implement object recognition in the surroundings of the user, such as offered by trained machine learning models trained to perform object recognition. The present embodiments in some embodiments constantly surveil an environment of the user to find the necessary items for an event. The present embodiments may include scraping online information to determine appropriate items to be taken for an event. Machine learning, in various embodiments, is used to determine the key necessary items for the program to add to the list. A user may be involved in the training of the machine learning model which generates the list based on the input of past events and/or upcoming events. Training the machine learning model by the user and/or with historical information of past events associated with the user or others may help improve the accuracy of the entries of the list with respect to what a respective user actually needs and/or wants for the event. In addition, the user may personally and/or manually customize the item list for an event and a priority ranking for items on the item list. Through the web-based and/or user-specific list generation, the present embodiments detect and prioritize an importance of an item relative to a specific upcoming task the user is about to undertake.

The present embodiments may include storing the locations of items in a database until a successful completion of a task such as departure for an event resets the database. Once a user takes the items, locations of the items have now changed. Thus, a reset or adjustment of the location database may be performed at that time of departure.

The present embodiments may also include a sleep mode where augmented reality notification of location changes of items is fully or partially disabled. In the sleep mode, the item location may be tracked without constantly providing new augmented reality updates to the user. The augmented reality notification update for a particular item may be reserved for time intervals in which the system is helping the user prepare for a current and/or soon-occurring task such as a departure. When the item is not on a list of a soon-occurring event for the user, the location update notification may be disabled for that item which may be referred to as a partial disablement of the notification. A user may also manually actuate the software to fully turn off the augmented reality notifications for a time interval, so that no notifications about location changes are provided for any tracked item during that time interval.

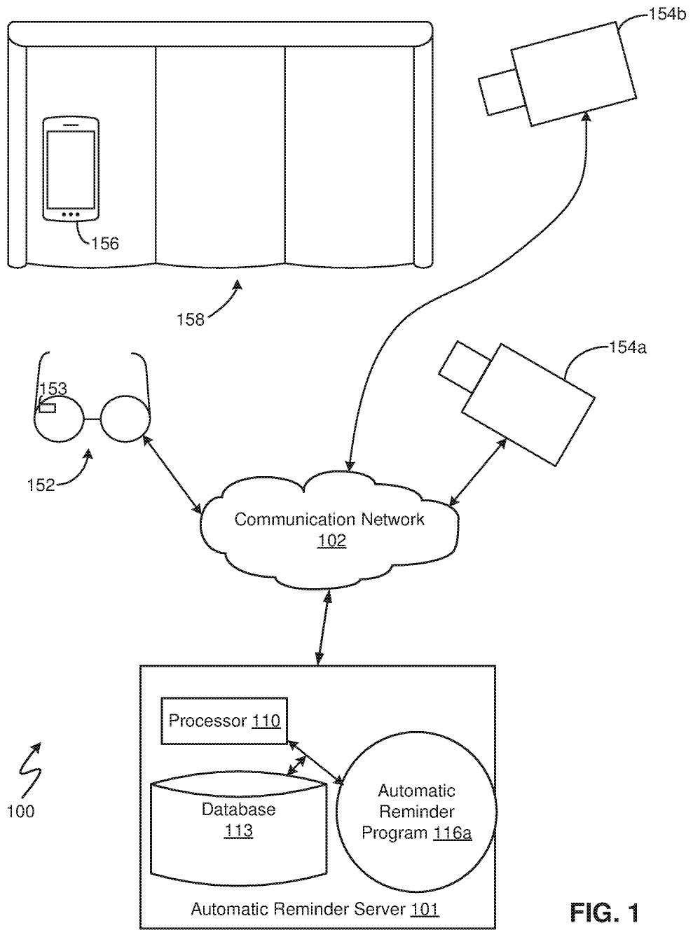

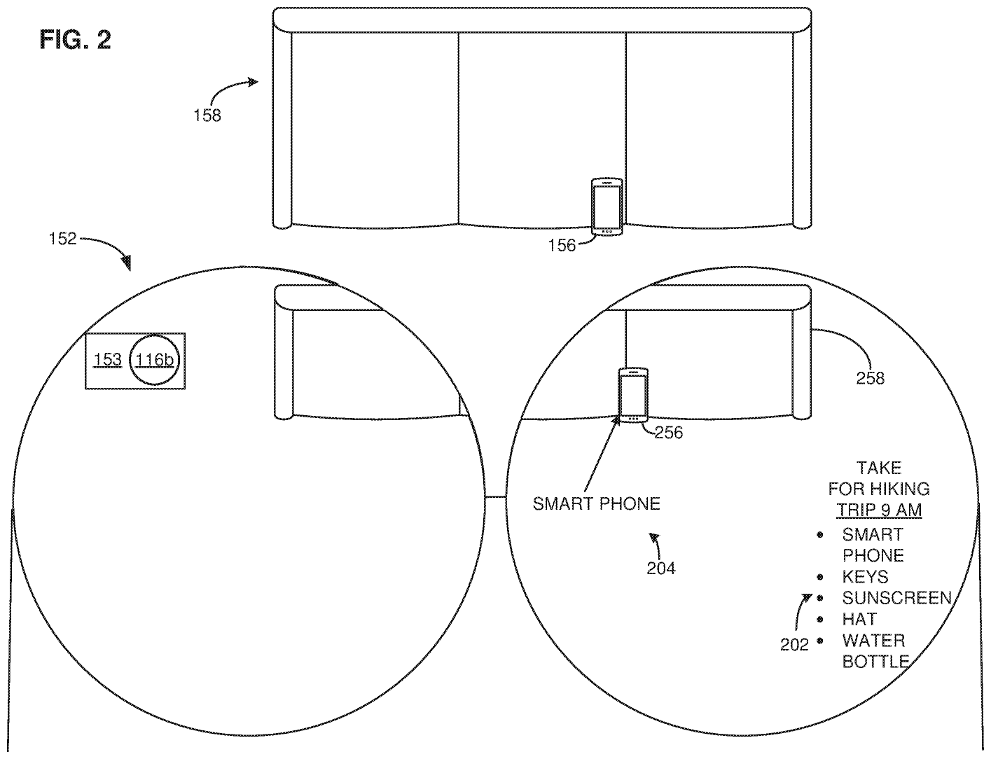

FIG. 1 illustrates an automated reminder AR environment 100 for item-related event tracking according to at least one embodiment. The automated reminder AR environment 100 in the depicted embodiment includes an automatic reminder server 101 that hosts an automatic reminder program 116a. The automated reminder AR environment 100 in the depicted embodiment also includes a pair of smart glasses 152 which hosts a smart glasses computer 153. The smart glasses computer 153 also hosts software to provide for communications with the automatic reminder program 116b. FIG. 2 shows the automatic reminder program 116b on the smart glasses computer 153 of the smart glasses 152. The automatic reminder server 101 also is shown in this embodiment as having a wireless connection to multiple cameras such as the first camera 154a and the second camera 154b (in various embodiments, a wired connection may be used in place of wireless connection for one or more of first camera 154a and second camera 154b). These first and second cameras 154a, 154b may be arranged to capture images from an environment such as the automated reminder AR environment 100 in which the smart glasses 152 are present. The environment such as the automated reminder AR environment 100 may be inhabited by a person who registers with the automatic reminder program 116a, 116b. The automatic reminder server 101 may in some instances be referred to as an item prioritizer system server.

In the automated reminder AR environment 100, one or more of the first camera 154a, the second camera 154b, and the smart glasses 152 may capture images of the local environment/surroundings and objects within the environment. For example, these images may include images of a first smart phone 156 and a couch 158, with the first smart phone 156 sitting on the couch 158. In some embodiments the first smart phone 156 may also include software allowing communications with automated reminder program 116 stored on a computer of the first smart phone 156; however, the first smart phone 156 is illustrated in FIG. 1 as an object to be tracked and it is unnecessary for an object whose location is being tracked to having any computer or to have any instance of the automated reminder program stored thereon.

The automatic reminder server 101 may transmit wireless communications with the smart glasses 152, with the first camera 154a, and with the second camera 154b via a communication network 102. The automated reminder AR environment 100 may include many computers, many cameras, and many servers, although one pair of smart glasses 152, two cameras 154a, 154b, and one server 101 are shown in FIG. 1. Any number of these is contemplated as within the scope of the invention. The communication network 102 allows communication between the computers, the smart glasses, the cameras, and the server. The communication network 102 may include various types of communication networks, such as the Internet, a wide area network (WAN), a local area network (LAN), a telecommunication network, a wireless network, a public switched telephone network (PTSN) and/or a satellite network.

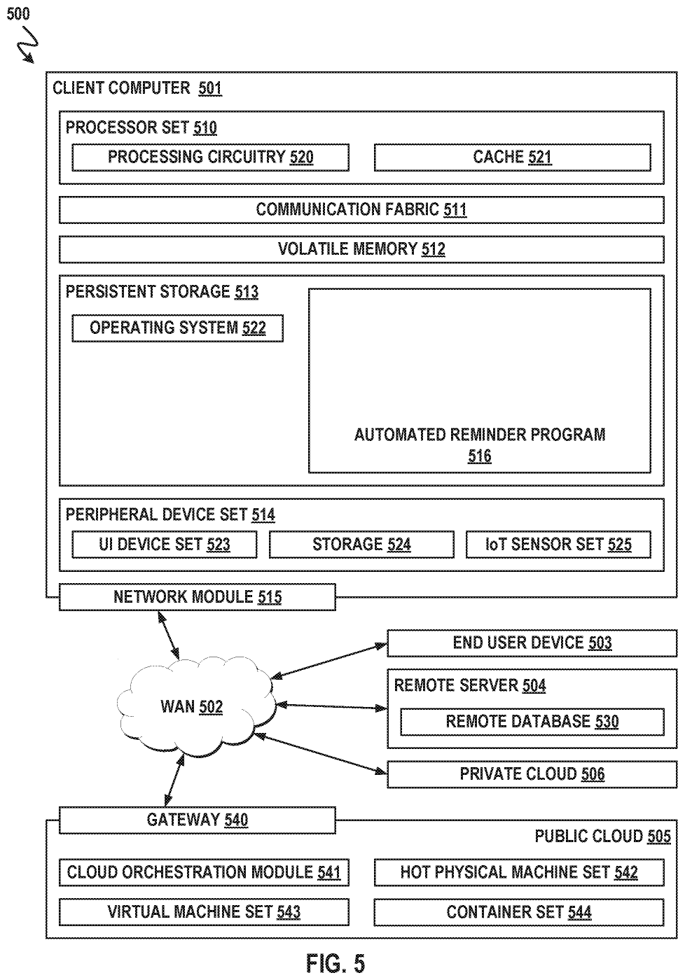

The communication network 102 may include connections, such as wire, wireless communication links, or fiber optic cables. The communication network 102 may itself include multiple servers such as a network edge server and an edge/gateway server which may be enabled to run or assist in operation of the automated reminder AR program. The communication network 102 may in some embodiments be or include high speed networks such as 4G and 5G networks. Implementing the present automatic reminder program 116a in a 5G network will enable at least some embodiments to be implemented on the edge in order to boost network performance. The communication network 102 may in some embodiments be equivalent to the wide area network 502 shown in FIG. 5 and subsequently described in this present disclosure.

As will be discussed with reference to FIG. 5, the automated reminder server 101 may be a mainframe server (or the equivalent) and may include the components of the client computer 501. Each of the smart glasses 152, the first camera 154a, and the second camera 154b may also include equivalent components of the client computer 501 shown in FIG. 5 including the automatic reminder program 116, executing in part of in the entirety on different elements disclosed in connection with FIG. 5. The server 101 may also in some embodiments relationally be equivalent to the remote server 504 shown in FIG. 5. The smart glasses 152, the first camera 154a, the second camera 154b, and in some instances the smart phone 156 may also in some embodiments relationally be equivalent (or otherwise related) to the end user device 503 shown in FIG. 5. Server 101 may also operate in a cloud computing service model, such as Software as a Service (Saas), Platform as a Service (PaaS), or Infrastructure as a Service (IaaS). Server 101 may also be located in a cloud computing deployment model, such as a private cloud, community cloud, public cloud, or hybrid cloud. The first camera 154a and the second camera 154b may each be, for example, a mobile device, a telephone, a personal digital assistant, a netbook, a laptop computer, a tablet computer, a desktop computer, or any type of computing devices that includes a camera and is capable of running a program, accessing a network, and accessing a database 113 in the server 101 that is located outside of the respective camera. The first camera 154a and the second camera 154b may each include a display screen, a speaker, a microphone, a camera, and a keyboard or other input device for better receiving setting adjustments for the automatic reminder program and/or camera settings. In some embodiments the first camera 154a and/or the second camera 154b capture and transmit image data to the server 101 without themselves hosting electronic list-generating software. According to various implementations of the present embodiment, the automatic reminder program 116a, 116b may interact with a database 114 that may be embedded in various storage devices, such as, but not limited to a various computers/mobile devices, the server 101 that may be in a network, or another cloud storage service such as the remote server 504 and/or the private cloud 506 shown in FIG. 5.

Usage of storing content on edge servers may reduce network traffic that is required for the item tracking and location reminders described herein. This reduction in network traffic may help achieve efficient processing for execution of the methods according to the present embodiments. The users of the automated reminder program 116a, 116b may utilize their network infrastructure to gain appropriate connectivity, e.g. 5G connectivity, into the environment. The present embodiments may take advantage of existing and future 5G infrastructure and its increase of bandwidth, latency, and scaling of applications requiring large amounts of real-time data. The server 112 may trigger data and command flows to be processed by distributed enhanced experience capability programs that are available at a network edge server located at a network edge and/or that are available at an edge/gateway server located at a network gateway. User profile tracking customization and profiles can also flow from the edge gateway/server through the network edge server for access by the server 112 which implements automated reminding.

The automated reminder server 101 in some embodiments includes one or more machine learning models disposed thereon (or otherwise available) that are accessible to the automated reminder program 116a. Such machine learning models may be used to perform various aspects associated with the automated reminder such as generating item-to-bring lists and/or departure checklists based on the input of a particular type of upcoming event and determining an object location based on the input of one or more item images and/or of one or more images of the item within a particular surrounding. Such machine learning models may be trained by the user and/or with historical information of past events and/or items associated with the user or others in order to improve the accuracy of the entries of the list generated and/or objects recognized. The automated reminder server 101 may include object recognition and tracking algorithms stored thereon. The database 113 of the automatic reminder server 101 may be equivalent to the persistent storage 513 shown in FIG. 5 and may store multiple directories related to the automatic reminder program 116a. Such directories may include item-to-bring lists for particular events, possible item locations within an environment, and items to track for a particular user. The automatic reminder server 101 may include a processor 110 which communicates with the automatic reminder program 116a and the database 113 and which may be equivalent to the processor set 510 shown in FIG. 5 and described subsequently in this disclosure.

A computer system with the automated reminder program 116a, 116b operates as a special purpose computer system in which the automated reminder process 200 assists in the performance of automated reminders for an upcoming event and that may include augmented reality display of the reminders. In particular, the automated reminder program 116a, 116b transforms a computer system into a special purpose computer system as compared to currently available general computer systems that do not have the automated reminder program 116a, 116b.

FIG. 2 illustrates an augmented reality view with a location reminder according to at least one embodiment. Thus, FIG. 2 illustrates one output of performing the automated reminder program 116 in the automated reminder environment 100 shown in FIG. 1. Specifically, the program 116 received a notification of an upcoming hike for a user who is registered with the program and associated with the smart glasses 152. The program 116a generates an item-to-bring list 202 for the upcoming hike and displays the item-to-bring list 202 as augmented reality superimposed over an image view of a user who is wearing the smart glasses 152. The smart glasses 152 includes the smart glasses computer 153 on which an instance of the automated reminder program 116b is stored.

Within the image view in the smart glasses 152 is a couch view 258 of the couch 158 in the physical environment as well as a smart phone view 256 of the smart phone 156 that is in the physical environment. Both the couch view 258 and the smart phone view 256 represent images of the actual physical environment, but the augmented reality module of the automated reminder program 116a, 116b generates the item-to-bring list 202 to be superimposed over the image view of the smart glasses 152. Thus, the user wearing the smart glasses 152 sees the item-to-bring list 202 along with other images of actual physical objects.

Under the stress of preparing for the hiking event, the user has forgotten what to take for the hike and also where the smart phone is within the environment. Thus, without the automated reminder program 116a, 116b the user may forget to go to the hike and spoil a planned outing with other friends or may go but be unprepared, e.g. not having the smart phone 156 for driving directions, hiking orientation, and/or for making an emergency call if necessary during the hike. The automated reminder program 116a. 116b generates the item-to-bring list 202, however, and may present items in the list in a prioritized manner, e.g. with a highest priority item at the highest portion of the list and items becoming less important in priority ranking moving downward from the top of the list.

The automated reminder program 116a, 116b may also present augmented reality directions 204 to guide the user to the location of an item in the item-to-bring list 202. Such directions 204 may be provided in the form of words and/or arrows superimposed on the display screen view. In the present embodiment, an arrow and the phrase “smart phone” are superimposed over the view as indicators to guide the user to the location of the smart phone 156 on the couch 158. Thus, the user may save time looking through the house for the object and may more quickly move through the item-to-bring list 202 to prepare for the event, e.g. for the hike. If the user moves toward the couch 158 and grabs the smart phone 156, e.g. places it in a clothing pocket and/or in a bag, images captured via the smart glasses 152 and/or via one of the cameras 154a, 154b may recognize that the user has secured the item for the event. The automated reminder program 116 may proceed to a next item on the item-to-bring list 202 and display virtual reality guidance to the location of the next item. This additional virtual reality guidance may also be displayed over the smart glasses view of the user surroundings and may guide the user to the location of the next item in the item-to-bring list 202, e.g. to the keys.

It should be appreciated that FIGS. 1 and 2 provide only an illustration of some environments or implementations and do not imply any limitations with regard to the environments in which different embodiments may be implemented. Many modifications to the depicted environments may be made based on design and implementation requirements.

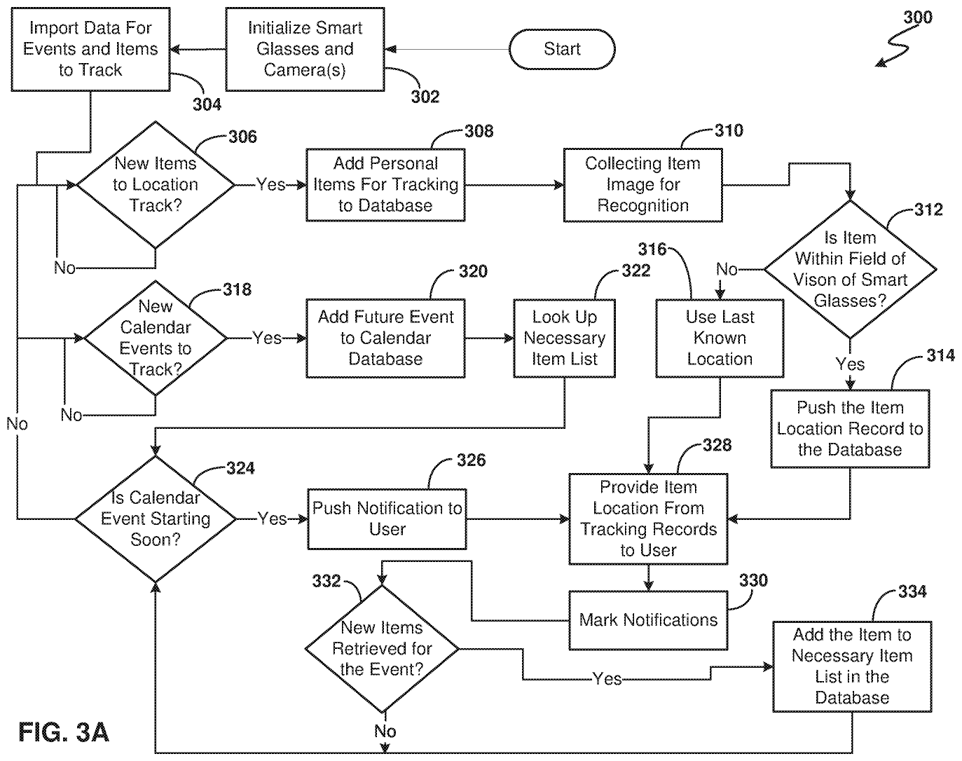

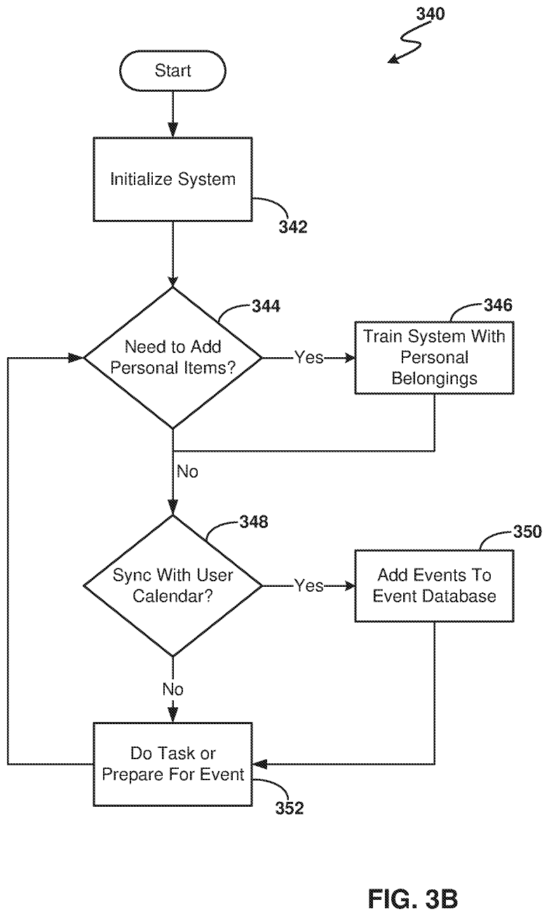

FIG. 3A is an operational flowchart illustrating an event-related item tracking process 300 according to at least one embodiment. This event-related item tracking process 300 may be implemented using one or more portions of the automated reminder program 110a. 110b shown in FIG. 1. The automated reminder program 110a, 110b may include and/or access various modules, user interfaces, services, machine learning models, personal information management software, and natural language processing tools and may use data storage when performing the event-related item tracking process 300. The event-related item tracking process 300 helps prepare the automated system for recognizing upcoming events and helping prepare the user to timely leave for the event, to know what items to bring for the event, and to find those items as was depicted in FIGS. 1 and 2 above.

In a step 302 of the event-related item tracking process 300, smart glasses and one or more cameras are initialized for use with the automated reminder program 116a, 116b. This initialization occurs with respect to a specific account for a user who has registered to use the automated reminder program 116a, 116b. The smart glasses may belong to the user or to another person or entity who has shared the smart glasses with the user. The cameras may be installed at a usual place of habitation of the user, e.g. at a home, a vehicle, an office, a warehouse, and/or other facility of the user. An additional computer may be registered to the account by the user with the automated reminder program 116a, 116b. Such additional computer may be any computer which may hold image data and may register with the automated reminder program 116a, 116b to download an instance of the automated reminder program 116. For example, the smart phone 156 shown in FIG. 1 may register with the system, may download an instance of the automated reminder program 116c (or other communication program for communicating with the automated reminder program 116a, 116b), may capture, with its smart phone camera, images of items to track, and may upload those images to the database. Users may choose to register with the automated reminder program 116a, 116b who want to track items, e.g. high value items, as a scenario occurs such as in preparation for a departure. In order to perform the registration, the user may actuate various graphical user interface buttons of a website and/or an app that are displayed on a display screen of the respective computer when the downloaded app is stored and executed. The display may include one or more scrollable lists or swipable graphics that are displayed on the display monitor of a local computer such as the smart phone 156 which the user may use for registration. The downloaded application may also be synched up with the one or more cameras such as the first and second cameras 154a, 154b of the environment.

As part of the registration, in various embodiments consent is requested and obtained by the automated reminder program 116b from the user to permit the program 116b to monitor an environment of the user, to access personal information management software associated with the user, and/or to track data such as calendar entries of the user. The program 116b may generate a graphical user interface to request and receive this consent from the user. The user may actuate a computer such as the smart phone 156 to engage the graphical user interface and provide this consent.

Although FIG. 1 and the event-related item tracking process 300 are described with smart glasses being implemented, the system and process may be implemented with other computers that have display screens, e.g. with other computers that are capable of implementing augmented reality over a camera view displayed on a display screen. A laptop with a camera and a display screen, a smart phone with a camera and a display screen, smart goggles, and/or some other computer with a camera and a display screen may analogously be implemented according to some embodiments for the performance of augmented reality display of an item-to-bring reminder list and/or directions to an item. In some embodiments, the augmented reality may be performed with any wearable device with visual capability.

The user account registration that is received may be stored in memory that is part of the automated reminder program 110a, 110b, 110c or that is accessible to the automated reminder program 110a, 110b, 110c. For example, information about the user, user preferences, and user devices may be saved in the database 113 shown in FIG. 1, in the storage 524 and/or persistent storage 513 of the client computer 501 shown in FIG. 5, in memory of a server such as the remote server 504 within and connected to the wide area network 502, in memory of an edge/gateway server or of a network edge server, and/or in other memory in one or more other remote servers that are accessible to the automated reminder program 110a, 110b, 110c via the wide area network 502 or via the communication network 102 via a wired or wireless connection.

The initialization of step 302 in at least some embodiments includes the input of cameras, camera positions in the surroundings/environment at the venue, and computers, e.g. the smart glasses, which have cameras or may establish a connection with the automatic reminder program 116b in the automatic reminder server 101. Using these input variables, the automatic reminder program 116a, 116b may generate a selection array for the registering user to decide which cameras may capture images for item tracking and which times the cameras should be enabled or disabled for camera tracking.

The initialization of step 302 in at least some embodiments includes the pairing of the computers and camera devices with the automatic reminder server 101. The automatic reminder server 101 may in this embodiment with pairing be in the environment in which the computers and camera devices are operating. For example, the smart glasses 152 need to be turned on and connected to an internet connection such as a home private cloud. A scan function may be activated on the server 101 to search for local connectable devices. An entry for the smart glasses 152 may be selected and an activation code for the smart glasses 152 may be generated. The user may then enter in this activation code at the smart glasses 152 as part of the pairing and/or registration. Due to the pairing, the smart glasses 152 may automatically transmit data to the automatic reminder server 101.

In a step 304 of the event-related item tracking process 300, data for events and items to track are imported into the automated reminder program 116a. 116b. This information may also be imported as part of an initial registration step for a user when the user establishes an account with the automated reminder program 116a, 116b and/or downloads the software for the automated reminder program 116a, 116b. The user may provide program access to a user calendar in which the user creates entries for upcoming events that the user plans to attend and/or for upcoming tasks or projects which the user plans to complete. The user may provide via text (e.g. via typing or speaking and using a text-to-speech transcription program, a list of items which the user plans to use and/or will need for the particular entry, e.g. for the particular event and/or the task/project.

In some embodiments, during this registration when the program 116b recognizes a type of event or project, the program 116b may generate a list of possible items needed for the event and the user during this registration may confirm item-by-item whether the user wishes to be reminded to bring the respective item during a future reminder.

The user may select a setting that will have certain items added to every reminder to-bring list in the future or for every event that includes a particular occurrence. For example, the user may select that the smart phone be added for the to-bring list for every event which includes leaving the residence.

In at least some embodiments, the user may also enter certain items so that the respective location of these items may be tracked by the program 116b. The user may capture and upload one or more pictures of these items that are transmitted to the program 116b. This uploading of pictures may help skip or reduce the learning curve that a machine learning model may need to identify various items in the surrounding/environment whose locations are being tracked. The user may provide a caption for each picture so that the program 116b may know the name of the item(s) to track from that picture. A computer registered with the program 116b, accessing a website of the program 116b, or paired with the automated reminder server 101 may provide such images to the program 116b. With this information, the program 116b may better decipher from the image data provided by the cameras 154a, 154b and/or smart glasses 152 images in which a respective item is present. Using this recognition, the program 116b may recognize and store a particular location for the item within the environment. The user images may be stored in data reserved for a user account with the program 116b. In some embodiments, the user may also for the account provide a typical location of an item to track, e.g. that the keys are usually within a storage drawer or hang from a rack in a particular room.

In some embodiments, these images with their captions may be used for supervised training of a machine learning model which receives image data of the surveilled environment and outputs locations of particular items within that environment. As part of the training, the machine learning model learns to recognize items in addition to recognize locations of the items.

In some embodiments, object location tracking is performed using a visual recognition module that is part of the automated reminder program 116a, 116b. The visual recognition module uses images such as snapshots to train a machine learning model, e.g. a semi-supervised machine learning model, to catalogue the personal belongings which the user wishes to location track.

After performance of step 304 of importing data, the event-related item tracking process 300 may flow to one or both of step 306 and step 318. In some embodiments the process flow may occur simultaneously through the branch that starts with step 306 and through the branch that starts with step 318.

In a step 306 of the event-related item tracking process 300, a determination is made whether there are new items whose location should be tracked. If the determination of step 306 is affirmative and at least one new item is recognized whose location should be tracked, the process 300 proceeds to step 308. If the determination of step 306 is negative and no new item is recognized whose location is to be tracked, the process may continually loop around step 306 until a new item is recognized or may proceed to step 318 for a possible sojourning through this branch.

In step 306, the determination may be made based on a manual entry by the user. The determination may also be made based on new image data received from the environment camera observation. An image recognition machine learning model may recognize one or more new items, may use machine learning to identify the items, and then may location track the items. The image recognition machine learning model may perform web scraping to find similar photos to help identify new items from the environment camera observations.

In a step 308 of the event-related item tracking process 300, personal items for tracking are added to the database. These personal items from step 308 refer to those new items identified in step 306. Using the text manually entered by the user and/or by using output of the image recognition machine learning model, the location of a new item is stored in a database such as the database 113 of the automatic reminder server 101. The location may be stored in an item location directory of the database 113.

In a step 310 of the event-related item tracking process 300, one or more item images are collected for recognition. The images for step 310 are for those items added to the database in step 308. The item images may be uploaded by the user with a caption and/or supervised learning of the item name and/or captured in general environment observation via the cameras 154a, 154b or the smart glasses 152. These item images may be stored in the database 113 and in the item location directory, e.g. attached to the item name in the item location directory. This step 310 may include analysis of the image information that has been received. For example, stored images of an item may be compared via the program 116a and/or via a machine learning model to confirm matches of new image information with respect to already-stored images.

In a step 312 of the event-related item tracking process 300, a determination is made as to whether the item is within the field of vision of smart glasses. If the determination of step 312 is affirmative and the item is within the field of vision of smart glasses, the process 300 proceeds to step 314. If the determination of step 312 is negative and the particular item is not within the field of vision of the registered smart glasses, the process may proceed to step 316. The program 116a, 116b may use an image recognition machine learning model to determine whether an item is currently within the field of vision of smart glasses such as the smart glasses 152. For example, in the instance shown in FIG. 2 an image recognition machine learning model of the program 116a, 116b may recognize that the smart phone 156 and the couch 158 are within the field of view of the smart glasses 152. In some embodiments, the field of view for step 312 may also include the field of view of one or more observation cameras such as the first camera 154a and the second camera 154b. This determination of step 312 that may invoke use of a machine learning model and/or other artificial intelligence may include analysis of the image information that has been received.

In a step 314 of the event-related item tracking process 300, the item location record is pushed to the database. For example, in the instance shown in FIG. 2 the item location record for the smart phone 156 may be on the couch or on the first couch, on the red couch, on the living room couch, etc. This record may be saved in the database 113. This pushing may occur via a data transmission to the automated reminder server 101 over a communication network such as the communication network 102 and/or a local wifi connection. In response to determining that the location of a tracked item has changed to an updated location, updated location information for this item is in various embodiments pushed to the location database and stored in this location database.

In a step 316 of the event-related item tracking process 300, the last known location of the item is used. When the item is not currently in the view of the smart glasses 152 or in the view of one of the cameras 154a, 154b, then a last known location of the item is maintained in the database 113 for this item or an unknown location entry is provided for this item entry in the database 113.

Steps 306, 308, 310, 312, and 314 or 316 may be performed via an object detection module which is part of the automated reminder program 116a, 116b. The object detection module may in some embodiments include or access an image recognition machine learning model. The object detection module may continue to work using an image set that is collected by the smart glasses and/or other observation cameras. After achieving the capability of recognizing the personal belongings which the user wishes to track, the system starts to trace the key frames as the item is present and disappears. The latest image is stored and may be used to remind users about the last location of the item and/or where the item was last used. The object detection module may be involved in the streaming of images to the automated reminder server 101 whereat computations are performed to determine if the item has been moved. The system caches the item and location information to build the latest location history of the item for future reference. The object detection module may analyze image information that is received in order to perform one or more of these steps.

In a step 318 of the event-related item tracking process 300, a determination is made whether there are new calendar events to track. If the determination of step 306 is affirmative and at least one new calendar event is recognized that should be tracked, the process 300 proceeds to step 320. If the determination of step 318 is negative and no new calendar entry is recognized for tracking for the user, the process may continually loop around step 318 until a new calendar entry is recognized or may proceed to step 306 for a possible sojourning through this branch.

The determination of step 318 may be made based on a manual entry by the user. The user may type or use speech-to-text to communicate a new calendar entry to the program 116a to track. If the user has granted the program 116a access to a private virtual calendar, any updating to the calendar such as adding a new event, project, or task in the calendar may trigger a positive determination of step 318. The determination may also be made based on user device tracking information. If the user grants the program 116a access to observe communications from a particular computer, an event-determining machine learning model may recognize an upcoming event or project. This recognition may occur by performing natural language processing on digital messages received and/or sent by the user computer. The program 116a. 116b may identify one or more new events the user commits to attend and then may enter this event or project into the reminder calendar. The event recognition machine learning model may perform web scraping to find public or community events that relate to an event discussed in the messages of the user computer. Step 318 in various embodiments includes accessing and/or communicating with personal information management software associated with the user in order to find, retrieve, and/or receive calendar items.

The program 116a may connect to a personal virtual calendar of the user (such as available in connection with personal information management software), may retrieve highlight schedules, and may gather weather data forecasts for the day and time of the new events. For example, the program 116a may determine that the user has scheduled an airplane flight to a destination city X on Friday night. The program 116a determines from the data information evaluation that the trip is for business purposes. The program 116a may via online web scraping retrieve from the forecasted weather data that rain is forecast during the time of traveling to the airport in the departure city and also is forecast during the time of scheduled arrival in the destination city X.

In a step 320 of the event-related item tracking process 300, a future event is added to the calendar database. This adding may occur via a transmission to the automated reminder server 101. The future event may be added into an event directory of the database 113 within the automated reminder server 101.

In a step 322 of the event-related item tracking process 300, a necessary item list is looked up. The necessary item list refers to items that the user should bring for the future event that was recognized in step 318 and added to the calendar database in step 320. The program 116a may perform a word comparison of the event title to other standard events in the program databases. The program 116a may retrieve standard item-to-bring lists from other events that are similar in name to the currently analyzed event. The database may recommend important items such as travel essentials for a particular type of event. For example, for travel a passport, a drivers license, a suitcase, a wallet, etc. may be provided by the program 116b to add to the necessary item list. For business events, a laptop and connecting cable, a business cell-phone and charger, business cards, etc. may be provided by the program 116b to add to the necessary item list. Based on weather forecast data retrieved, weather-related items such as an umbrella for rain may be provided by the program 116b to add to the necessary item list.

In some embodiments, the looking up of step 322 includes accessing a user-customized necessary-item list for a particular event or based on the type of event. A user may manually enter items which the user wants to bring for an event or project. These items may be retrieved in step 322 for the particular event or for a similar event, e.g. with a similar title.

In some embodiments, the looking up of step 322 may include some web-scraping to determine appropriate items to bring for a particular event or project. For example, if the new event is a project to complete, the program 116b may search the web for articles and/or videos which describe how to complete such a project. The program may analyze text, images, and/or audio (e.g. by performing speech-to-text transcription of such audio) from such online sources in order to generate the necessary item list. The program may find actual lists presented from the online sources or may generate a list of important nouns from the text data and present those to the user as possible items to include for the item-to-bring list. The user may confirm and/or reject such program-proposed entries for the item-to-bring list.

In a step 324 of the event-related item tracking process 300, a determination is made whether a calendar event is starting soon. If the determination of step 324 is affirmative and at least one new calendar event is starting soon, the process 300 proceeds to step 326. If the determination of step 324 is negative and no new calendar event is starting soon, the process may loop back to steps 306 or 318 for a repeat of the branches of those steps 306 or 318.

Step 324 may be performed by accessing data from the personal program calendar for the user and comparing the entries to a pre-determined threshold. The pre-determined threshold may be set by the program 116a, 116b or by the user who indicates a preference for particular amounts of advance notice and/or departure preparation time for the event. For example, if the user has indicated a preference to be reminded two hours before departure time for travel to an airport, the program 116b may determine the travel time needed to arrive at the airport in advance of the flight and may give the warning at the specified amount of time before the necessary departure time. Thus, the user would be given a certain amount of time to retrieve the necessary items to take before leaving.

In a step 326 of the event-related item tracking process 300, a notification is pushed to the user. This notification relates to the event which in step 324 was determined as starting soon. The notification may include an event reminder with details about the scheduled start time, a needed departure time, and the necessary item list (item-to-bring list). This notification may be sent via a transmission from the automated reminder server 101 to a computer associated with the user. For example, the reminder may be sent with the generation and transmission of a text reminder message which the user receives via SMS, via an email in personal information management software, via an instant messaging platform, etc. In some embodiments, the reminder may be sent via the generation and display of an augmented reality reminder on a display screen of the user. For example, a reminder notification may be displayed on the image view of the smart glasses 152. FIG. 2 shows an example of an augmented reality reminder for a hiking trip that is scheduled for today and that departure time for this hiking trip should be 9:00 AM. The augmented reality display may in some embodiments be displayed in a peripheral area of the view of the display screen, e.g. of the smart goggles view. The item-to-bring list 202 may also be displayed as augmented reality superimposed over the actual physical view of the display screen. FIG. 2 shows that the item-to-bring list 202 for the hiking event may include a smart phone, keys, sunscreen, a hat, and a water bottle. The item-to-bring list 202 is depicted as being superimposed over a peripheral portion of the field of view of the smart glasses 152 and does not interfere with a more central view of objects such as the couch 158 and the smart phone 156 that are viewed by the smart glasses 152. This recommended checklist may be popped up to the user at the specified notification time. For example, the notification time could be one day before departure, or a specified number of hours before the needed departure time, etc.

In a step 328 of the event-related item tracking process 300, an item location from the tracking records is provided to the user. The program 116a. 116b retrieves from the database 113 the stored item location for one or more of the items provided on the item-to-bring list for the event. The location information is retrieved and transmitted to a user computer for presentation to the user. In at least some embodiments, the location information is transmitted to the user computer for augmented reality display of instructions for the user to proceed to the item location. For example, in the embodiment depicted in FIG. 2 the program 116a, 116b may provide augmented reality directions 204 to guide the user to the location of the first item, namely the smart phone 156, on the item-to-bring list 202. These augmented reality instructions may include words and/or arrows which guide the user to the location. The location information may be transmitted so as to pop up for display on the user computer. The location information may represent the actual location of the item. The location information may include a name and/or physical coordinates of the location. For an environment that is regularly frequented and/or inhabited by the user, the program 116a, 116b may host and/or generate a virtual three-dimensional map of the environment so as to implement physical landmarks (e.g. walls of a house) and to track item locations more precisely within the three-dimensional map, e.g. using three-dimensional coordinates with the map as a reference. The location information in various embodiments includes arrow information that is usable by the program 116a, 116b to generate the arrow that is superimposed over a field of view of an area on a display screen and that points the user viewing the augmented reality display to the location of the item. The transmitting of the location information for presentation to the user in various embodiments includes transmitting updated location information for the respective item for presentation of the updated location information to the user.

In some embodiments, the notifications of a soon-approaching event, item-to-bring list, and/or item location information of steps 326 and/or 328 may be transmitted in a digital manner for an alternative presentation than via augmented reality display. For example, the notifications may be sent for presentation via a text display on a display screen of the user computer and/or via an audible playing of audible information via a speaker of the user computer.

In a step 330 of the event-related item tracking process 300, the notifications are marked. The program 116a, 116b may continue to capture and evaluate image data to determine when the user has successfully retrieved and secured, for departure or for project beginning, items from the item-to-bring list. The program 116a, 116b may, for example, determine if items from the item-to-bring list have been inserted into a travel bag or suitcase. In other embodiments, the user may be able to manually enter, e.g. via a graphical user interface and a computer input device, once an item has successfully been retrieved and secured for travel. Marking such an item as retrieve and secured whether via a manual marking or via image classification may cause the program 116a, 116b to send the location information for the next item on the item-to-bring list.

In some embodiments, the program 116a, 116b may also perform bag tracking for the travel. Once an item has been placed into a bag, the program 116a, 116b may via a manual entry or via image data evaluation recognize that the bag should be taken for the trip. After retrieval of the individual items, the program 116a, 116b may switch to visual camera observation and reminder notifications for the one or more bags themselves.

The program 116a, 116b may allow the user to provide feedback in step 330 about particular items that are recommended. For example, the program 116a, 116b may generate a graphical user interface which may allow the user to mark one or more recommended items as not applicable or as to be ignored for this event preparation.

The program 116a, 116b may also generate an extra notification, e.g. via an audio transmission or a visual transmission, e.g. via a visual augmented reality display, if the program 116a, 116b recognizes that the user has missed an item from the item-to-bring list 202. This recognition may be based on image data analysis from a continual image stream sent from the user computers and/or cameras such as the smart glasses 152, the first camera 154a, and/or the second camera 154a.

In a step 332 of the event-related item tracking process 300, a determination is made whether there are new items that were retrieved for the event. If the determination of step 332 is affirmative and at least one new item was retrieved for the event, the process 300 proceeds to step 334. If the determination of step 332 is negative and no new item was retrieved for the event, the process may proceed to step 324 for a repeat of other steps of the process 300. This determination of step 332 may be performed via examining manually entered data from the user and/or via analysis of image data received from the smart glasses 152 and/or from the cameras 154a, 154b.

In a step 334 of the event-related item tracking process 300, the item is added to the necessary item list in the database. The new item refers to the new item recognized in step 332. The program 116a. 116b may generate a new entry for the new item and transmit this new information to the database 113 for storage as a new entry in the item-to-bring list for this particular type of event. Thus, the next time a similar scenario or event occurs an updated item-to-bring list may be pushed to the user computer to remind the user to include such a particular new item. Thus, the reminder system achieves continual learning as an improvement of artificial intelligence models and provides enhancement over a static reminder system that may only be adjusted via manual entry.

After completion of event preparation, the program 116a, 116b may generate insights to help prepare for future events. The program 116a, 116b may better be able to recognize future events to involve in the process 300 and items to be included for event preparation. For example, the program 116a, 116b may recognize the departure arrangement and travel scenario based on the given calendar and identify that this event is scheduled or likely to happen in the future. The program 116a, 116b may generate and propose a new calendar entry for presentation to the user to confirm if such a future event is indeed already scheduled. The program 116a, 116b may log the latest location of the items during the event but also keep gathering image data to determine what items are present and frequently used during that time frame. This observation may help in personal customization of item-to-bring lists. For example, for a flight scenario the program 116a, 116b may recognize that the user prefers to bring a travel neck pillow, noise cancelling headsets, earphones, etc. The program 116a, 116b may add these items to the item-to-bring list for the customized flight item list for the user and/or for the customized travel item list for the user.

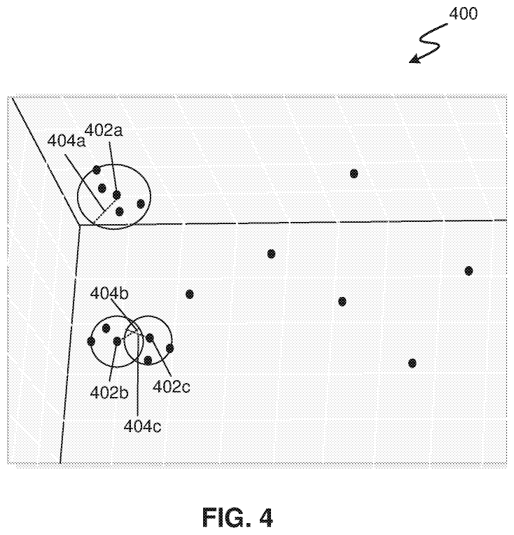

The program 116a, 116b may also determine possible related scenarios by performing semantic similarity examination for event terminology. Such examination may include generating word embeddings of the event descriptions and submitting the embeddings to a clustering algorithm as will be explained subsequently with respect to FIG. 4. The program 116a, 116b may in this regard recognize semantic similarity for various types of events. For examples, other types of travel such as a road trip or train travel may be recognized as being similar to air travel. Therefore, item-to-bring lists for these other travel events may be similar and/or have shared content/entries with the flight item-to-bring list. Such similar events may have similar tags according to a clustering algorithm. The program may retrieve recommended items to bring from the lists for the other similar events and add these and/or suggest these for addition to the other similar event. For example, the system may recommend that an item commonly used for a road trip be part of an item-to-bring list for a flight.

The program 116a, 116b may also continue to perform object detection once the event is over. The program 116a, 116b may continue to receive image information from the environment in order to observe item locations and to identify new items. One or more cameras such as, from the automated reminder environment 100 shown in FIG. 1, the first camera 154, the second camera 154b, a camera that is part of the smart glasses 152, and/or a camera that is part of the smart phone 156 may obtain such continued image information. This continual monitoring may help the program 116a, 116b update the location of any items if a location change is identified. The program 116a, 116b may also wait for a new event for which reminder notifications should be generated.

Machine learning models may be implemented for the various steps of process 300 such as the image recognition, item location tracking, calendar entry tracking, and necessary item list generation. Such machine learning models may include naive Bayes models, random decision tree models, linear statistical query models, logistic regression n models, neural network models, e.g. convolutional neural networks, multi-layer perceptrons, residual networks, long short-term memory architectures, algorithms, deep learning models, deep learning generative models, and other models. Training data includes the samples, text information, and/or image data of suitable events, items to track, and appropriate items-to-bring lists. The learning algorithm, in training the machine learning models in question, finds patterns in input data in order to map the input data attributes to the target. The trained machine learning models contain or otherwise utilize these patterns so that the recommendations and recognition can be predicted for similar future inputs. A machine learning model may be used to obtain predictions on new entries and/or new event preparation. The machine learning model uses the patterns that are identified to determine what the appropriate recognition and generation decisions are for future data to be received and analyzed. As samples are being provided, training of the one or more machine learning models may include supervised learning by submitting prior lists, images, calendars, and/or calendar entries to an untrained or previously-trained machine learning model. In some instances, unsupervised and/or semi-supervised learning for the one or more machine learning models may also be implemented.

FIG. 3B is an operational flowchart illustrating a user side 340 of the event-related item tracking process 300 shown in FIG. 3A and according to at least one embodiment. This user side process 340 may be used with some of the computers, servers, cameras, and/or smart glasses shown in the automated reminder environment 100 shown in FIG. 1 and that use the automated reminder program 116a, 116b. The automated reminder program 110a, 110b may include various modules, user interfaces, services, machine learning models, and natural language processing tools and may use data storage when the user side process 340 is performed.

In a step 342 of the user-side process 340 of the event-related item-tracking process, the system is initialized. This may include user registration and is similar to the initialization step 302 that was described with respect to process 300 shown in FIG. 3A.

In a step 344 of the user-side process 340, a determination is made whether the user needs to add personal items for the automated reminder program 116a, 116b. If the determination of step 344 is affirmative and new personal items are to be added, the user-side process 340 proceeds to step 346. If the determination of step 344 is negative and no personal item needs to be added to the tracking program, the user-side process 340 may proceed to step 348. The user may manually engage with a graphical user interface of the program 116a, 116b to provide customized information about personal items to track.

In a step 346 of the user-side process 340, the system is trained with images and/or other data regarding personal belongings. The user may upload images with text captions to name the personal belongings. The program 116a, 116b may feed this information to an object recognition module including to a machine learning model of the object recognition module. This inputting of image and naming information may be a way to train the machine learning model for this particular user.

In a step 348 of the user-side process 340, a determination is made whether the system needs to sync with personal information management software such as the user calendar. The user may view a program-specific list of personal entries and/or calendar entries and manually request (via engaging a graphical user interface) a syncing action if the program-specific calendar looks out of date. If the determination of step 348 is affirmative and the user calendar does needs to sync with the program calendar, the user-side process 340 proceeds to step 350. If the determination of step 348 is negative and the user calendar does not need to sync with the program calendar, the user-side process 340 may proceed to step 352.

In a step 350 of the user-side process 340 of the event-related item-tracking process, events are added to the event database. The program 116a, 116b may retrieve entries from the user calendar and add them to the program-specific calendar. The program 116a, 116b may generate a confirmation graphical user interface to request confirmation if a particular item should be added.

In a step 352 of the user-side process 340 of the event-related item-tracking process, the task is performed or the user prepares for the event. The event preparation or task performance is used with the assistance of the program 116a, 116b providing location assistance and item-need assistance for the project or event.

After step 352, the user-side process 340 proceeds to step 344 for a repeat of certain steps of the user-side process 340, e.g. for program location tracking of new items and/or to receive program help for preparing for other events.

It may be appreciated that FIGS. 3A and 3B provide illustrations of some embodiments and do not imply any limitations with regard to how different embodiments may be implemented. Many modifications to the depicted embodiment(s), e.g. to a depicted sequence of steps, may be made based on design and implementation requirements.

FIG. 4 illustrates a graph 400 of vector features of event descriptions according to at least one embodiment. Each point in the multi-dimensional graph 400 represents an event description for a particular event, task, and/or project that may be added for reminders in the automated reminder program 116a, 116b. The text of event descriptions may be submitted to an autoencoder that encodes the text descriptions to generate vectors and embeds the text descriptions into a latent space. The vectors are high-level representations of the text descriptions. The embedded data may be passed through a clustering algorithm to produce the multi-dimensional graph 400. The clustering algorithm may be included as part of an autoencoder of the automated reminder program 116a, 116b or may be a separate component of another computer that runs the autoencoder. At least one embodiment may include a fuzzy k-mean clustering approach, because a deep clustering may require knowing the number of classes in advance. When the k is computed by an algorithm, a partition entropy algorithm, a partition coefficient algorithm, or other algorithms may be used. The high level vector features may also be based on semantic similarity of words from the event descriptions as the words had been used in other text corpuses that have been used to train the autoencoder.

In FIG. 4, event descriptions vectors are shown as black dots scattered throughout the multi-dimensional graph 400. Similar event descriptions may fall in similar locations on the graph and may be grouped into a cluster. FIG. 4 shows three identified clusters, with a first cluster having a first cluster centroid 402a, a second cluster having a second cluster centroid 402b, and a third cluster having a third cluster centroid 402c. Each cluster may also have a radius which helps define the size of the cluster. The three clusters are shown with a first cluster radius 404a, a second cluster radius 404b, and a third cluster radius 404c, respectively. The second cluster radius 404b is shown as overlapping with the third cluster radius 404c so that event description vectors within these second and third clusters may be deemed sufficiently semantically similar for necessary item sharing. In other words, the entries from a necessary item list for an event description falling within the second cluster may be added and/or suggested for addition to the necessary item list for any event whose description vector lies within the second cluster and for any event whose description vector lies within the third cluster. The first cluster is shown as not overlapping another cluster so event description vectors within the first cluster may likewise share necessary items with each other from their necessary item lists. The size of the radius may depend on the scattering of data points and on the presence or lack of other clusters or centroids in the vicinity.

The autoencoder may generate the event description vectors as word embeddings that may be a set of hundreds/thousands of dimensions and vectors, and the numbers of dimensions and vectors for the multiple embeddings may be on the same or a similar scale to allow plotting of the embeddings in a consistent multi-dimensional space such as the multi-dimensional graph shown in FIG. 4.

It may be appreciated that FIG. 4 provides an illustration of one clustering example and does imply any limitations with regard to how different embodiments may be implemented. Many modifications to the depicted embodiment(s), e.g. to a depicted clustering technique, may be made based on design and implementation requirements.

In at least some embodiments, an inventive method may include initializing a system to track high value items as a scenario occurs. This tracking may be referred to as a departure checklist. A connection between an item system server and a vision device may be established, e.g. via pairing the two computers. A further computer with a camera (e.g. a smart phone) may further be connected to the item system server. This connection of the additional camera may allow the uploading of image data that is immediately available for use. This image data may include an image set of the items the user wants to track. Using this image set may help to skip or reduce the learning curve for an image recognition machine learning model to learn to identify items within the view of the cameras. The various devices and cameras and vision device, e.g. smart glasses, may continuously track the surrounding items and may use an object detection module to do the tracking. The object detection module may be trained using the image set collected by the smart glasses/vision device. A visual recognition module of the system server may be trained using the snapshots in a semi-supervised learning model to catalog personal belongs of a user. Key frames in the snapshots of the image data may be tracked as the item is present and disappears out of frame. The latest image may be stored and used to remind users about the last location of the item. An indicator displaying the location of the item may be generated and displayed, e.g. as augmented reality on a vision device such as smart glasses, in order to guide the user to the location of an item. The user can configure the system to display text location output.

Item tracking may be optimized based on user feedback/requirements. The program may connect to a calendar account of the user, may retrieve the calendar highlight schedules, and may also gather weather data. The program may alert the user at a specified time before departure about preparing needed items such as a travel suitcase. The program may generate a recommended items checklist which pops up with the corresponding latest item location history from the database to help guide the user for event preparation, e.g. for a successful departure to travel to and participate in an event. The program may glean and provide preparation insights based on past events. The program may recommend items that are required for the situation. The program may determine related event preparation lists by finding “possibly related scenario” tags of clustering algorithms, e.g. in a general training model. For example, traveling by flight will be related to other ways of travel like a road trip or train trip and would have a similar tag. Recommended items from one related event could be added to and/or suggested for addition to another related event.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 shown in FIG. 5 contains an example of an environment for the execution of at least some of the computer code involved in performing the inventive methods, such as automated reminding 516. In addition to automated reminding 516, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and automated reminding 516, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in automated reminding program 516 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in automated reminding program 516 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments. UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501) and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments. EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for event-related item tracking, the method comprising:
receiving, via a first computer and from an event database associated with personal information management software, a reminder of an upcoming event for a first user;
retrieving, via the first computer, an electronic list of items needed by the first user for the upcoming event;
retrieving, via the first computer and from a location database, location information of a first item from the electronic list of items, wherein the location database was generated using image information associated with the first item; and
transmitting, via the first computer, the electronic list of items and the location information of the first item for presentation to the first user.

2. The method of claim 1, wherein the transmitting of the location information of the first item comprises a transmission for augmented reality presentation of the location information of the first item.

3. The method of claim 2, wherein the location information is transmitted with arrow information, for generating as augmented reality, an arrow displayed on a display screen superimposed over a field of view of an area, the arrow pointing to a location of the first item.

4. The method of claim 1, further comprising transmitting a pairing signal from the first computer to a second computer associated with a first camera for generating the image information for the location database.

5. The method of claim 1, wherein the first computer is associated with a camera and the method further comprises:
receiving, via the first computer and from the camera, the image information of the first item;
analyzing, via the first computer, the image information;
determining, via the first computer, a location of the first item based on the analysis; and
storing, via the first computer, the location information in the location database, the location information representing the location of the first item.

6. The method of claim 5, further comprising:
receiving, via the first computer and from the camera, updated image information of the first item;
analyzing, via the first computer, the updated image information;
determining, via the first computer and based on the analysis of the updated image information, whether the location of the first item has changed to an updated location; and
in response to determining that the location has changed to an updated location, storing, via the first computer, updated location information for the first item in the location database, wherein the transmitting of the location information for the first item for presentation to the first user comprises transmitting the updated location information for the first item for presentation of the updated location information to the first user.

7. The method of claim 1, further comprising:
receiving, via the first computer and from the event database, a reminder of a second upcoming event for the first user; and
obtaining, via the first computer, an electronic list of items needed by the first user for the second upcoming event, the obtaining comprising performing clustering of event similarity, finding a first cluster comprising the second event and a third event, and retrieving an electronic list of items for the third event.

8. The method of claim 1, further comprising:
retrieving, via the first computer, weather data that is forecasted for a timing of the upcoming event; and
adjusting, via the first computer, the electronic list of items for the first event based on the retrieved weather data.

9. A computer system for event-related item tracking, the computer system comprising:
one or more processors, one or more computer-readable tangible storage media, and program instructions stored on at least one of the one or more computer-readable tangible storage media for execution by at least one of the one or more processors to cause the computer system to:
receive, from an event database associated with personal information management software, a reminder of an upcoming event for a first user;
retrieve an electronic list of items needed by the first user for the upcoming event;
retrieve, from a location database, location information of a first item from the electronic list of items, wherein the location database was generated using image information associated with the first item; and
transmit the electronic list of items and the location information of the first item for presentation to the first user.

10. The computer system of claim 9, wherein the transmitting of the location information of the first item comprises a transmission for augmented reality presentation of the location information of the first item.

11. The computer system of claim 10, wherein the location information comprises arrow information that is usable to generate, as augmented reality, an arrow displayed on a display screen superimposed over a field of view of an area, the arrow pointing to a location of the first item.

12. The computer system of claim 9, wherein the program instructions stored on the at least one of the one or more computer-readable tangible storage media are further for execution by at least one of the one or more processors to cause the computer system to transmit a pairing signal to another computer associated with a first camera for generating the image information for the location database.

13. The computer system of claim 9, wherein the program instructions stored on the at least one of the one or more computer-readable tangible storage media are further for execution by at least one of the one or more processors to cause the computer system to:
receive, from a camera, the image information of the first item;
analyze the image information;
determine a location of the first item based on the analysis; and
store the location information in the location database, the location information representing the location of the first item.

14. The computer system of claim 13, wherein the program instructions stored on the at least one of the one or more computer-readable tangible storage media are further for execution by at least one of the one or more processors to cause the computer system to:
receive updated image information of the first item;
analyze the updated image information;
determine, based on the analysis of the updated image information, whether the location of the first item has changed to an updated location; and
in response to determining that the location has changed to an updated location, store updated location information for the first item in the location database, wherein the transmitting of the location information for the first item for presentation to the first user comprises transmitting the updated location information for the first item for presentation of the updated location information to the first user.

15. The computer system of claim 9, wherein the program instructions stored on the at least one of the one or more computer-readable tangible storage media are further for execution by at least one of the one or more processors to cause the computer system to:
receive, from the event database, a reminder of a second upcoming event for the first user; and
obtain an electronic list of items needed by the first user for the second upcoming event, the obtaining comprising performing clustering of event similarity, finding a first cluster comprising the second event and a third event, and retrieving an electronic list of items for the third event.

16. The computer system of claim 9, wherein the program instructions stored on the at least one of the one or more computer-readable tangible storage media are further for execution by at least one of the one or more processors to cause the computer system to:
retrieve weather data that is forecasted for a timing of the upcoming event; and
adjust the electronic list of items for the first event based on the retrieved weather data.

17. A computer program product for event-related item tracking, the computer program product comprising a computer-readable storage medium having program instructions embodied therewith, the program instructions being executable by a computer to cause the computer to:
receive, from an event database associated with personal information management software, a reminder of an upcoming event for a first user;
retrieve an electronic list of items needed by the first user for the upcoming event;
retrieve, from a location database, location information of a first item from the electronic list of items, wherein the location database was generated using image information of the first item; and
transmit the electronic list of items and the location information of the first item for presentation to the first user.

18. The computer program product of claim 17, wherein the transmitting of the location information of the first item comprises a transmission for augmented reality presentation of the location information of the first item.

19. The computer program product of claim 18, wherein the location information comprises arrow information that is usable, for generating as augmented reality, an arrow displayed on a display screen superimposed over a field of view of an area, the arrow pointing to a location of the first item.

20. The computer program product of claim 17, wherein the program instructions are further executable by a computer to further cause the computer to transmit a pairing signal from the computer to another computer associated with a first camera for generating the image information for the location database.
